(19) United States
(12) Patent Application Publication
(10) Pub. No.: US 2018/0205321 A1
(43) Pub. Date: Jul. 19, 2018

(54) Adaptive Transceiver Power Supply

(71) Applicants: Domenic D'Angella, Germantown, MD (US); Eric Maksymyk, Merritt Island, FL (US)

(72) Inventors: Domenic D'Angella, Germantown, MD (US); Eric Maksymyk, Merritt Island, FL (US)

(21) Appl. No.: 15/410,403

(22) Filed: Jan. 19, 2017

(51) Int. Cl. H02M 7/00; H02J 9/06; H02J 7/00; H04B 1/3883

(52) U.S. Cl. CPC H02M 7/003; H02J 9/061; H04B 1/3883; H02J 7/0068; H02J 7/0042

(57) ABSTRACT

There is provided an adaptable transceiver power supply which is based on discrete modules consisting of severable and reversible modules including a transceiver adapter module. The adaptable transceiver power supply consists of a discrete AC/DC module; a DC module and a transceiver adapter which is used to affix the power modules to various transceivers while utilizing the basic power supply modules. The adaptability of the power supply allows power cable connections in either a left or right hand configuration. These modules may be used in a full AC/DC configuration or the AC/DC module may be removed from the system and the system may be used in a DC only power configuration.

### BACKGROUND OF THE INVENTION

The present invention relates generally to an integrated adaptive modular power supply which is based on the manufacture of discrete power supply modules and discrete adapter module. The power supply, also known as a battery eliminator, consists of 3 primary components. The first component is the AC-DC module which receives AC input voltage and provides DC output voltage. The second module receives DC input voltage and provides DC output voltage and also incorporates a lithium battery. The modules may be connected together to provide DC output voltage, or the AC module may be removed and the power supply may be used in only the DC or battery mode.

Power supplies are used to provide, or convert alternating current (AC) or direct current (DC) from a fixed or mobile location and convert this energy into the appropriate voltage and current for use in powered electronic applications. The design and use of these devices has been essentially the same using a design which connects power cables to the rear of the power supply and the power supply then connecting to the powered device.

Additionally, the invention allows the user to select either a right side, or left side power configuration for installation adaptability. The present invention moves the primary power supply cords from the fixed rear or fixed one side of the power supply to the user defined side and provides each module with its own input and output power connectors. Current designs are configured such that the user of the equipment must use a single large fixed device with both AC and DC modules in a single box.

### BRIEF SUMMARY OF THE INVENTION

Disclosed herein is an innovative method of manufacturing an automated switching power supply by the design and manufacture of the AC and DC/with Battery components as separate modules. This invention is useful and unique by allowing the user to select either one or both modules for operation. The design allows for automated sensing of voltage input and automated voltage conversion to the correct module. The invention is adaptive to the specific use scenario and is designed such that the symmetry of the design allows the modules to be reversed allowing power connections from either the left or right side, or the use of only the DC/Battery module without the AC module or both the AC and DC modules.

### BRIEF DESCRIPTION OF THE DRAWINGS

It should be noted that identical features in different drawings are shown with the same reference numeral.

FIG. 1 is a left side perspective view of one embodiment of the present invention showing a Harris 117 radio.

FIG. 2 is a right side perspective view of one embodiment of the present invention showing a Harris 117 radio.

FIG. 3 is a left side perspective view showing modularity.

FIG. 4 is a left side perspective view showing only the DC module configuration.

FIG. 5 is a left side perspective view showing all modules without the radio.

FIG. 6 is a right side perspective view showing all modules without the radio.

FIG. 7 is a left back elevation showing a change in configuration.

FIG. 8 is a left front elevation showing a change in configuration.

### DETAILED DESCRIPTION OF THE INVENTION

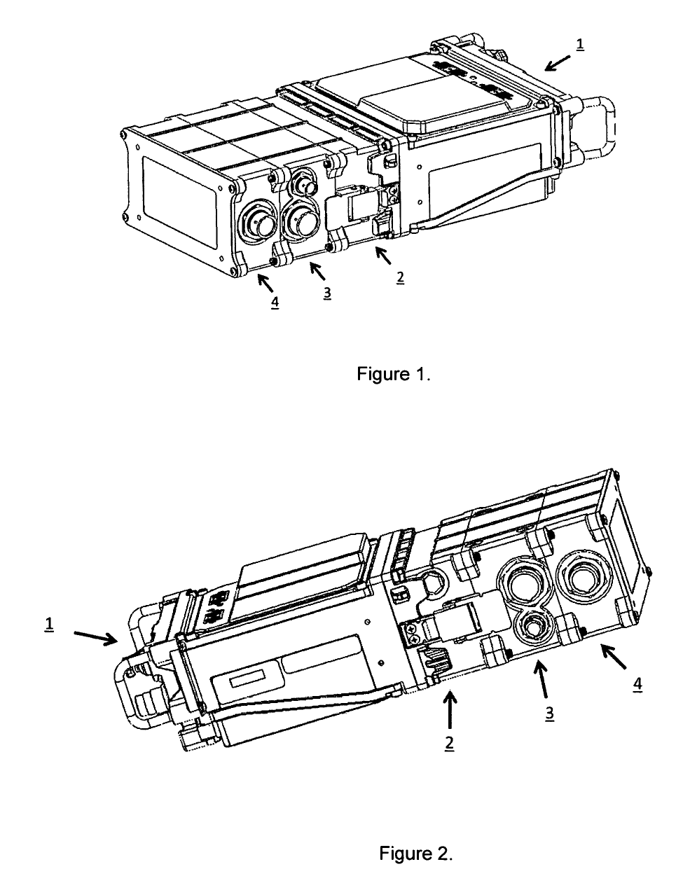

An example embodiment of the present invention is illustrated in FIGS. 1-7, where like portions share like numbering and left, right, top and bottom side orientation is always viewed from the front of the invention.

Referring now to FIG. 1. The figure shows an embodiment of the invention as attached to a powered transceiver. The transceiver is not part of the invention but illustrates the method of attachment. In this embodiment the power supply modules, 2,3,4 are assembled into one unit where 2 is the adaptor, designed to adapt to various powered devices; 3 is the DC and Battery module and 4 is the AC module. The transceiver is shown as 1. In this embodiment all connectors are shown on the left side.

Referring now to FIG. 2, the figure shows the adaptability features of the invention by allowing the ATPS to be reversed for input power connection with all connectors on the right side versus the configuration shown in FIG. 1, the left side.

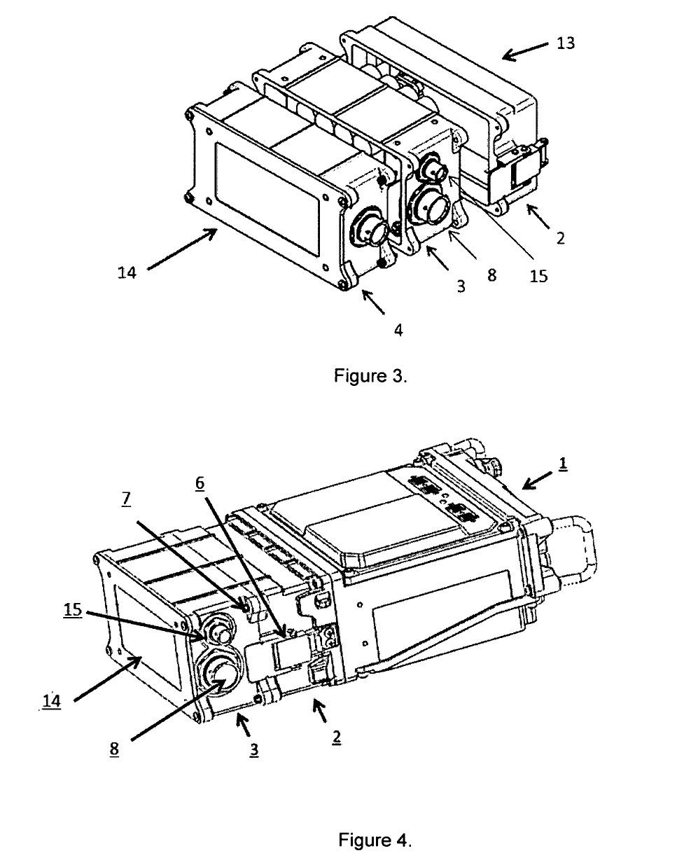

Referring now to FIG. 3 the three primary modules are shown in an example embodiment in which all three modules, 2,3,4 would be used, but are shown in an exploded view for clarity demonstrating the adaptive nature of the invention. The invention allows the AC power supply module 4 to be removed from the assembly allowing the Back Plate 14 to be affixed to the rear of the DC power supply assembly, 3, that is affixed to the adapter assembly 2 and the powered device 1. It further allows the DC power supply assembly 3 to be affixed to the device adapter 2 in such a matter that allows the DC input connector 8 and the auxiliary DC output connector 15 to be on the left or right side, when viewed from the front of the powered device. Referring now to FIG. 1, it is shown that all the assemblies 2,3,4, are affixed and connected to the powered device 1 and the AC input 9, DC input 8 and the auxiliary DC output 15 connectors are on the left side when viewed from the front of the powered device. Referring now to FIG. 2, it is shown that all the assemblies 2,3,4, are affixed and connected to the powered device 1 and the AC input 9, DC input 8 and output 15 connectors extend laterally to the right side when viewed from the front of the powered device allowing operational flexibility to the user.

Referring now to FIG. 3, it is shown that the assemblies 2,3,4 are separable and when used only in a DC-DC configuration the backplate 14 is removed from module 4 and affixed to module 3.

Referring now to FIG. 4, an example embodiment of the invention is shown minus module 4 and the backplate 14 is affixed to module 3 constituting a fully functional device without the AC module and supporting only DC input power. FIG. 4 shows the connection of modules 2 and 3 using the quick connect latches 6 and affixed to the powered device using an example attachment by using screws 7. In this example configuration the DC input 8 and the DC output 15 are shown on the left side but the adaptability of the invention allows the reversal of module 3 such that the connectors would be viewed on the right side of the invention.

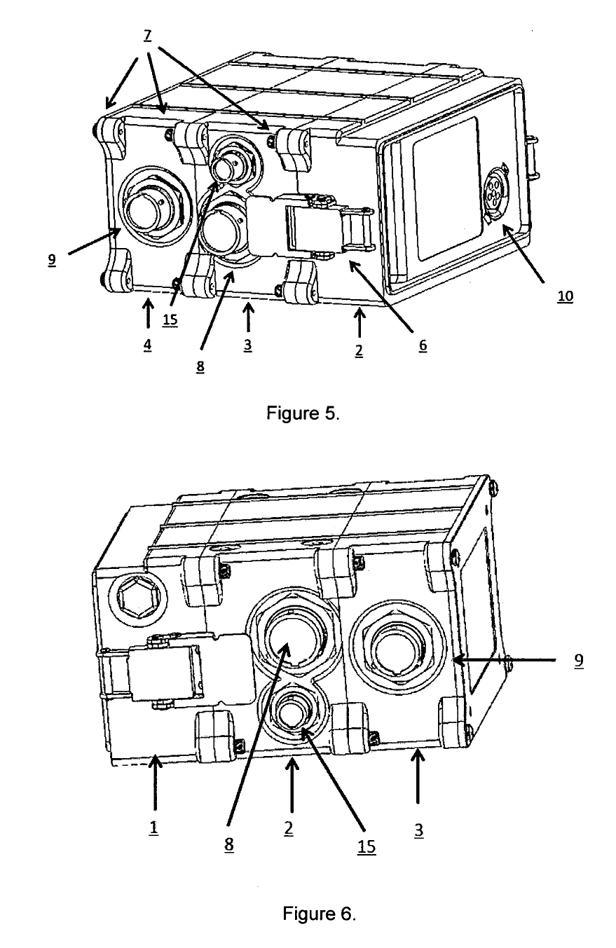

Referring now to FIG. 5 an example embodiment of the invention is shown. This figure shows the three component parts assembled together to provide AC-DC, DC-DC and/or battery backup power conversion. Device adapter, 2, is used to mate to the powered device and contains the primary electrical interface connection 10. The adapter is shown as an example configuration. Adapter design and configuration will vary based on the specific powered device in use. The DC-DC module 3 is shown attached to the device adapter 2 through the use of mounting screws, 7, which hold modules 3,4 securely to the adapter. The adapter 2 connects to the powered device, in this example, through the use of quick connect latches 6. The AC-DC adapter 4 is attached to the DC-DC module through the use of mounting screws, 7. The power connectors and the modules 3,4 are reversible by rotating them 180 degrees such that the right side becomes the left side allowing the invention to receive, and output, power from either the left or right side, or simultaneously the left and right side.

Referring now to FIG. 6, the symmetrical mechanical mounting design of the individual adaptive assemblies 2,3,4 allows the configurations described in above detailed descriptions. This view shows all connectors configured for left side power connections.

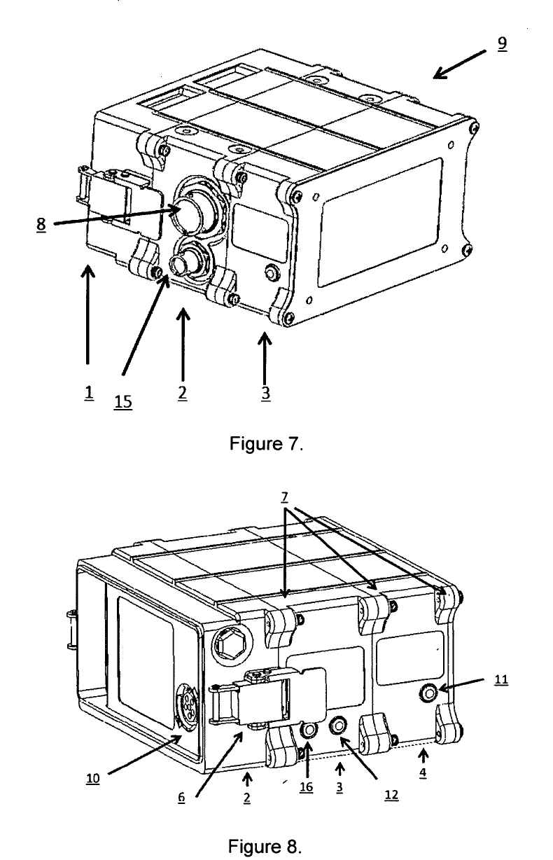

Referring now to FIG. 7, this embodiment demonstrates a configuration where the DC module connectors are on the left side, and the AC module, 4, connectors are on the rights side.

Referring now to FIG. 8, this view illustrates the association of LED status lights to the operation of the device. LED status indicator lights, 11, 12, and 16 are shown. LED 12, is electrically associated with the DC power supply 3 and will illuminate when the DC power supply is active and DC voltage is regulated into nominal DC voltage levels required for proper operation of the powered device 1, and outputs the regulated power to first connector 10 to allow for powering of the device 1 when affixed onto the device adapter assembly 2. LED 16 is electrically associated with the battery backup supply located internally of the DC power supply assembly 3 and will illuminate when the Battery backup supply is fully charged and proper DC voltage is sensed to operate the device 1 if both the AC 4 and DC 3 power supply assemblies fail. LED 11 is electrically associated with the AC power supply 4 and will illuminate when the AC power supply 4 converts alternating current into direct current at voltage levels required for the powered device 1 and outputs the converted power to first connector 10 to allow for powering of the device 1 when affixed onto the device adapter assembly 3.The LED indicator lights are affixed to their respective modules, and are adaptable symmetrically with the associated module 3,4.

In as much as power supply conversions, regularizing and power switching are well-known in the electrical arts, further discussion as to the electrical characteristics and properties of the internal power supplies for converting standard AC into direct current or regulating DC voltage will not be discussed as they are not necessary for a complete understanding of the invention herein described. While the invention is shown in several forms, it will be obvious to those skilled in the art that it is not so limited but is susceptible to various configurations and modifications without departing from the spirit thereof. Moreover, the physical dimensions of the front adapter assembly and the location and orientation of the electrical receptacle on the front of the radio adapter invention could easily accommodate different types of devices. In general, it is physically dimensioned to meet various types of device configurations.

What is claimed is:

1. A new method of producing automated power supplies for military radios. The method which separates the primary component parts, the AC-DC module, and the DC-DC module, into individual modules allowing the user of the equipment to tailor the device to a specific use scenario. The modules are attached to the powered device through the use of an adapter which allows the modules to be configured for left or right side power cable attachment. The modules are connected to each other using mounting screws, although quick connect latches may also be used.
a. first radio adapter, first AC and first DC power supply module with rechargeable battery backup electrically and mechanically affixed, having a front, left, right, top, bottom and back side for supporting at least one powered device;
b. An adapter assembly comprising base having a front side, left, right, top and a back side, said assembly being adapted and arranged for supporting a powered device and allowing independent adaptation and arrangement of said AC and DC power supply modules, the adapter being configured for specific powered devices acts as the interface between the power supply modules and the powered device;
c. a first AC power supply electrically connected with said first connector, said first AC power supply being housed within said assembly;
d. a first DC power supply and backup battery power supply, said first DC power supply each being electrically connected with said first connector and housed within said assembly;
e. a plurality of power supplies housed within at least part of said assembly;
f. a first said AC to DC power supply module electrically and mechanically affixed with said first radio adapter module and first connector, configurable to be rotated 180 degrees and allow the input power connectors to be located on the left or right side, the AC to DC power supply comprising an AC Power supply converting AC input to DC output;
g. a first said DC power supply electrically and mechanically affixed with said first radio adapter module and or first AC power supply module and first connector, said first DC power supply configurable to be rotated 180 degrees and allowing the input power connectors to be located on the left or right side, the DC/DC power supply comprising a DC Power input and built-in battery back-up regulating and providing nominal output to operate the powered device;
h. where the first AC to DC power supply affixed to the first DC to DC and battery backup power supply is electrically prioritized to provide power to the powered device;
i. where the first AC to DC power supply affixed to the first DC to DC power and battery backup supply will switch automatically to the DC power supply should the AC power supply fail.
j. where the first AC to DC power supply affixed to the first DC to DC power supply will switch automatically to back up battery if both AC and DC input power fail.
k. a first connector being adapted and arranged for supplying power from at least one of said plurality power supplies to said powered device;

2. A new method of assembling automated power supplies for military radios which provides for the assembly and use of individual modules, and the adaptability of these modules to use either a left or a right side electrical connection by rotating individual modules 180 degrees and reconnecting it to the powered device allowing flexibility in its use from existing power supplies. The device is manufactured in such a way that the symmetry of the modules allows for connection to other modules irrespective of top or bottom.
